(19) United States
(12) Patent Application Publication
(10) Pub. No.: US 2013/0201474 A1
(43) Pub. Date: Aug. 8, 2013

(54) Aberrometer for Measuring Parameters of a Lens Using Multiple Point Sources of Light

(71) Applicant: Bausch & Lomb Incorporated, Rochester, NY (US)

(72) Inventors: Daozhi Wang, Webster, NY (US); Ming Lai, Dublin, CA (US)

(73) Assignee: Bausch & Lomb Incorporated, Rochester, NY (US)

(21) Appl. No.: 13/756,633

(22) Filed: Feb. 1, 2013

Related U.S. Application Data
(60) Provisional application No. 61/595,748, filed on Feb. 7, 2012.

(51) Int. Cl. G01M 11/02

(52) U.S. Cl. CPC G01M 11/0242
USPC 356/124

(57) ABSTRACT

A device for measuring a lens, comprising apparatus for maintaining the lens at a location, at least a first point source, a second point source and a third point source, at least a first beam splitter, and a second beam splitter, and a wavefront sensor configured and arranged to receive a wavefront of light from the first source, a wavefront of light from the second source, and a wavefront of light from the third source after the light from each source has passed through the lens. The point sources and beam splitters are arranged such that the first source has a first object distance relative to the location, the second source has a second object distance relative to the location, the third source has a third object distance relative to the location, the first object distance, the second object distance, and the third object distance being different than one another.

### CROSS REFERENCE

This application claims the benefit of Provisional Patent Application No. 61/595,748 filed Feb. 7, 2012 which is incorporated by reference herein.

### FIELD OF INVENTION

The present invention relates to aberrometers, and more particularly to aberrometers for measuring parameters of a lens using multiple point sources of light.

### BACKGROUND OF THE INVENTION

It is known to measure optical parameters of a lens under test (e.g., effective focal length and principal plane locations) using an aberrometer. Aberrometers comprise a light source, the light from which is projected through the lens to generate a wavefront which is analyzed to calculate the parameters. Typically, the source is a point source or a collimated light source. The design of a given aberrometer for measuring optical parameters is the result of trade-offs (e.g., speed and accuracy) that result, for example, from selection of a source and selection of techniques for analyzing wavefronts.

One example of an aberrometer 100, which uses a fiber optic 102 having an end 104 that operates as a point source to project light through a lens under test 110, is shown in FIG. 1A. To determine parameters of lens 110, multiple measurements are made, each with end 104 in a different axial location. The light is captured by a Shack Hartmann sensor 120 for analysis. The resulting data is expressed as an image location as a function of point source location, from which optical parameters can be calculated. An optical relay 130 can be employed to facilitate configuration of the aberrometer and acquisition of data from the aberrometer.

Another example of an aberrometer 150, which uses collimated light to form a source 152 to project through a lens under test 160, is shown in FIG. 1B. The light is captured by a Shack Hartmann sensor 170 for analysis. Parameters of lens 160 can be calculated from a single measurement. An optical relay 180 can be employed to facilitate configuration of the aberrometer and acquisition of data from the aberrometer. While such an arrangement requires the capture of light over only a brief interval of time without any movement of the source being needed, the arrangement is highly dependent on positioning of lens 160 relative to Shack Hartmann sensor 170. By comparison, first example aberrometer 100 is insensitive to lens position but the process of making multiple measurements is time consuming. Any given aberrometer may be appropriate for a given application and inappropriate for another application. For example, one arrangement may be more appropriate for laboratory use and another more appropriate for in-line measurement during manufacturing.

There remains a need for an aberrometer that is relatively fast and relatively positionally insensitive.

### SUMMARY

Aspects of the present invention are directed to a device for measuring a lens under test, comprising A) apparatus for maintaining the lens at a location, B) at least a first point source, a second point source and a third point source, C) at least a first beam splitter, and a second beam splitter, and D) a wavefront sensor configured and arranged to receive a wavefront of light from the first source, a wavefront of light from the second source, and a wavefront of light from the third source after the light from each source has passed through the lens. The point sources and beam splitters are arranged such that the first source has a first object distance relative to the location, the second source has a second object distance relative to the location, the third source has a third object distance relative to the location, the first object distance, the second object distance, and the third object distance being different than one another.

In some embodiments, the apparatus is configured to hold a fluid and to maintain the lens in the fluid.

In some embodiments, the device further comprises a fourth point source and a third beam splitter, such that fourth point source has a fourth object distance relative to the location, the fourth object distance being different than the first object distance, the second object distance and the third object distance.

### BRIEF DESCRIPTION OF THE DRAWINGS

Illustrative, non-limiting embodiments of the present invention will be described by way of example with reference to the accompanying drawings, in which the same reference number is used to designate the same or similar components in different figures, and in which:

FIG. 1A is a schematic illustration of a first example of a prior art aberrometer;

FIG. 1B is a schematic illustration of a second example of a prior art aberrometer;

FIG. 2 is a schematic illustration of an example of an aberrometer according to aspects of the present invention; and

FIG. 3 is a schematic illustration of a lens under test (LUT) showing parameters relevant to a given measurement scheme.

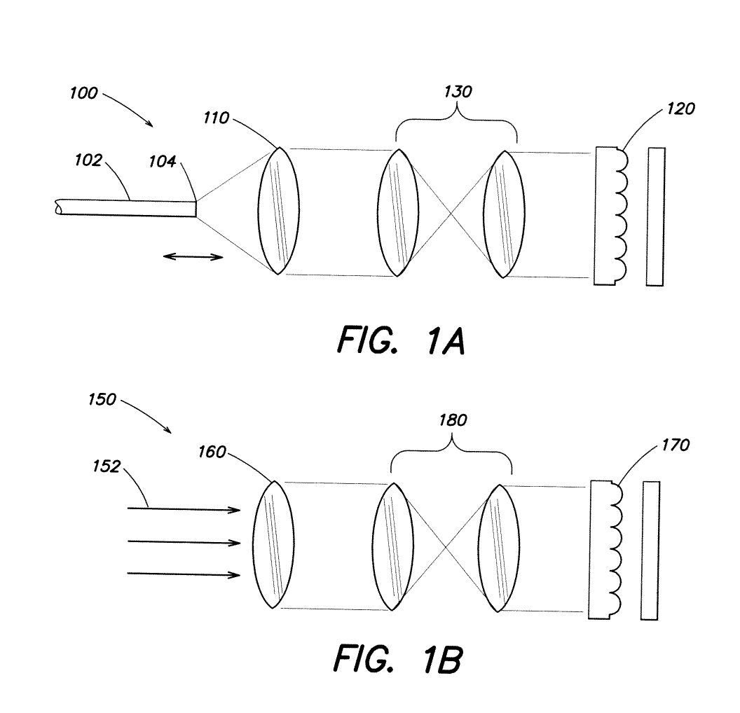

### DETAILED DESCRIPTION

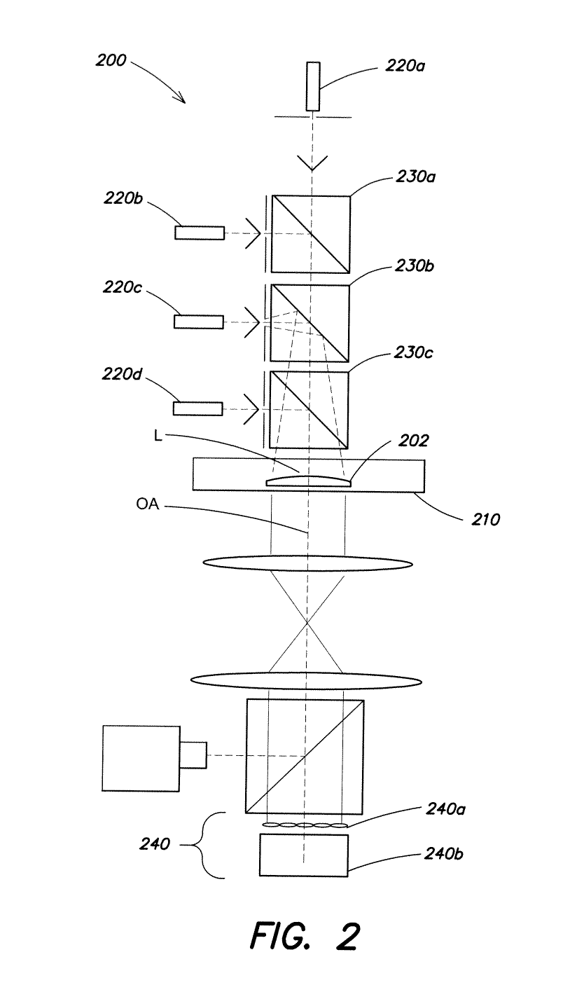

FIG. 2 is a schematic illustration of an example of an aberrometer 200 for measuring a lens under test 202 (e.g., an intraocular lens or a contact lens) according to aspects of the present invention. The aberrometer comprises apparatus 210 for maintaining the lens 202 at a location L, a plurality of light sources 220a-220d, a plurality of beam splitters 230a-230c, and a wavefront sensor sensor 240 (e.g., a Shack Hartmann sensor). The apparatus 210 may be a cuvette or other IOL holder that has a clear optical aperture to permit projection of light through the lens 202.

Apparatus 210 for maintaining the lens at a location may comprise any suitable structure for maintaining a lens in a position for measurement. Typically, the apparatus is configured to maintain a fluid such that the lens is maintained in a hydrated state. The plurality of sources comprises at least a first point source 220a, a second point source 220b and a third point source 220c. For example, the point source may be formed using light projected from an end of an optical fiber. In another embodiment, the point source may be formed with an LED behind a pinhole.

The plurality of beam splitters comprises at least a first beam splitter 230a, and a second beam splitter 230b, each operating to direct a spherical wavefront originating from a point source to propagate along the optical axis OA of lens 202. In some embodiments, the beam splitters 230 are cube beam splitters having an antireflective coating for a working wavelength, e.g. in embodiments for use with intraocular lenses, a visible wavelength.

Point sources 220 and beam splitters 230 are arranged such that the first source 220a has a first object distance relative to location L, the second source 220b has a second object distance relative to location L, the third source 220c has a third object distance relative to location L. The first object distance, the second object distance, and the third object distance are different than one another.

Wavefront sensor 240 may be any suitable configuration now known or later developed. For example, sensor 240 may comprise a lenslet array 240a and an optical sensor 240b. Wavefront sensor 240 is configured and arranged to receive a wavefront of light from first source 220a, a wavefront of light from the second source 220b, and a wavefront of light from the third source 220c after the light from each source has passed through lens 210. The light is received sequentially, e.g., first from source 220a, then from 220b and then from 220c.

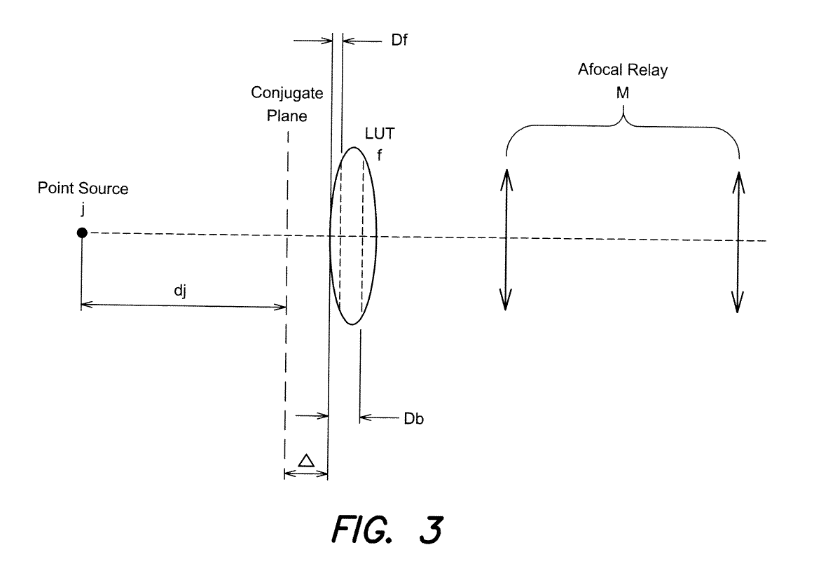

In one example embodiment, the lens parameters to be measured are effective focal length (f), location of a front principle plane (D_{f}), and location of a back principle plane (D_{b}). Referring to FIG. 3, for a given jth point source location dj, the following equation can be obtained using the lens makers' equation.

1/f=1/(dj+Δ+D_{f})+1/(−(1000/M²φₘⱼ)−(Δ+D_{b})) Equation 1

where dj is the distance between the jth point source and conjugate plane of the wavefront sensor, M is the magnification of an afocal relay system, and Δ is the distance from the lens under test apex to the conjugate plane.

All of Δ, M and dj are known parameters for a calibrated measurement system. φₘⱼ is a direct reading of optical power from the wavefront sensor with the sensor receiving light from the jth point source. For a lens under test, there are three unknowns f, D_{f} and D_{b}. Accordingly, three equations, each corresponding to a given point source location dj (j=1, 2, and 3), can be obtained to solve for the three unknowns. It will be appreciated that values of φₘⱼ, each corresponding to a given point source location dj, can be obtained by sequentially operating point sources to project light through the lens. An additional one or more point sources 220d can be illuminated to obtain a fourth or more equations which provides redundancy of data or as a check of the data from the remaining three point source 220a-220c.

In some embodiments for measuring IOLs, point sources 220a-220d are located 33 mm, 40 mm, 50 mm and 100 mm away from the conjugate plane. In some instances, aberration readings are obtained for a given lens upon illumination with each of the point sources. In some instances, the reading corresponding to the minimum calculated optical power is chosen to calculate the aberrations of the IOL, as this is the test condition that the point source is located closest to the front focal point of the test lens 202.

In some embodiments, a set of certified glass standards is used in place of an IOL to calibrate the aberrometer to determine M and Δ. Typically, the glass standards are either plano-convex or plano-concave, having a known effective focal length and thickness. A plane wave is input to the glass standard (i.e., d=infinity). Under such conditions, Equation 1 simplifies to form the following equation.

fᵢ+T=−1000/M²φₘᵢ−Δ Equation 2

where fi and Ti refer to the effective focal length and thickness of the ith glass standard, respectively, and the front surface of the glass standard is the plano surface of the lens, i.e. D_{f}=0 and D_{b}=Tᵢ.

It will be appreciated that by fitting measurement data φₘᵢ, fᵢ+Tᵢ resulting from different glass standards to a linear Equation 2, the calculated slope gives the value of magnification (M²) and the intersection with the x-axis gives the value of Δ.

In some instances, calibration can be achieved with no intraocular lens in place (i.e., f=infinity and Db=Df=0) to determine dj. Under such conditions, Equation 1 simplifies to form the following equation.

dⱼ=1000/M²φₘⱼ Equation 3

Having thus described the inventive concepts and a number of exemplary embodiments, it will be apparent to those skilled in the art that the invention may be implemented in various ways, and that modifications and improvements will readily occur to such persons. Thus, the embodiments are not intended to be limiting and presented by way of example only. The invention is limited only as required by the following claims and equivalents thereto.

What is claimed is:

1. A device for measuring a lens under test, comprising:
A) apparatus for maintaining the lens at a location;
B) at least a first point source, a second point source and a third point source;
C) at least a first beam splitter, and a second beam splitter,
the point sources and beam splitters arranged such that the first source has a first object distance relative to the location, the second source has a second object distance relative to the location, the third source has a third object distance relative to the location,
the first object distance, the second object distance, and the third object distance being different than one another; and
D) a wavefront sensor configured and arranged to receive a wavefront of light from the first source, a wavefront of light from the second source, and a wavefront of light from the third source after the light from each source has passed through the lens.

2. The device of claim 1, wherein the apparatus is configured to hold a fluid and to maintain the lens in the fluid.

3. The device of claim 1, further comprising a fourth point source and a third beam splitter, such that fourth point source has a fourth object distance relative to the location, the fourth object distance being different than the first object distance, the second object distance and the third object distance.
